(19) United States
(12) Patent Application Publication
(10) Pub. No.: US 2025/0351067 A1
(43) Pub. Date: Nov. 13, 2025

(54) ADAPTIVE APPROACH TO RADIO POWER MANAGEMENT

(71) Applicant: Cisco Technology, Inc., San Jose, CA (US)

(72) Inventors: Sangram Kishore Lakkaraju, Bangalore (IN); Srinath Gundavelli, San Jose, CA (US); Vimal Srivastava, Bangalore, Karnataka (IN)

(21) Appl. No.: 18/657,271

(22) Filed: May 7, 2024

(51) Int. Cl. H04W 52/02; H04W 36/08; H04W 60/04; H04W 76/30

(52) U.S. Cl. CPC H04W 52/0206; H04W 36/08; H04W 60/04; H04W 76/30

(57) ABSTRACT

A method, computer system, and computer program product are provided for triggering a low power operating mode for a radio access network. Connectivity criteria are obtained for each of a plurality of user equipment (UEs) connected to a radio access network comprising a plurality of radio base stations. It is determined that at least one radio base station of the plurality of radio base stations can be placed in a low power operating mode based, at least in part, on the connectivity criteria of one or more user equipment connected to the at least one radio base station. The at least one radio base station is caused to enter into the low power operating mode.

### TECHNICAL FIELD

The present disclosure relates generally to network equipment and services.

### BACKGROUND

In environments where Private 5G (P5G) is deployed, the power consumption of a gNodeB (gNB) radio may vary based on the time of the day. When a serviced area is active (e.g., during work hours), there is typically a high session count. At off-peak times, however, the session count goes down until the network may hardly be in use. Additionally, some gNBs may only have a small number of connected devices during certain times of day.

### BRIEF DESCRIPTION OF THE DRAWINGS

FIG. 1 is a block diagram depicting an environment for providing a low power operating mode for a radio access network, according to an example embodiment.

FIGS. 2A-2C are block diagrams depicting a radio access network in which a low power operating mode is activated, according to an example embodiment.

FIG. 3 is a signaling flow diagram depicting a method for providing a lower power operating mode for a radio access network, according to an example embodiment.

FIG. 4 is a flow chart depicting a method for providing a low power operating mode for a radio access network, according to an example embodiment.

FIG. 5 is a block diagram depicting a computing device, according to an example embodiment.

### DETAILED DESCRIPTION

### Overview

According to one embodiment, techniques are provided for triggering a low power mode for a radio access network (RAN). Connectivity criteria are obtained for each of a plurality of user equipment (UEs) connected to a RAN comprising a plurality of radio base stations. It is determined that at least one radio base station of the plurality of radio base stations can be placed in a low power operating mode based, at least in part, on the connectivity criteria of one or more user equipment connected to the at least one radio base station. The at least one radio base station is caused to enter into the low power operating mode.

### Example Embodiments

In many RANs, the number of user equipment (UEs) connected to radio base stations (e.g., gNodeBs) varies throughout the day, providing an opportunity to perform power-saving operations during off-peak hours. In many cases, the majority of radio base stations can be powered down. The logic regarding which radio base stations can be selectively powered off can depend on the number of connected devices and the nature of those devices. In the case of devices which are always connected, some may be essential for a facility's operations whereas others may be non-essential. When a given radio base station has just two connected devices and both are non-essential devices, for example, the network can choose to shut down that radio base station.

There are also scenarios where there are one or two devices at every gNodeB (gNB), and all of those devices require connectivity. It is logical for the network to move these devices to a small number of gNBs and to shut down all other gNBs. To bring such intelligence into the network requires the ability to classify devices as essential or non-essential from a connectivity point of view. There may be other tags in this context which can be used in the network power management decisions. Another consideration for power saving schemas can be based on a conditional policy in which the connectivity to a UE is required only when there is a primary device on which the UE depends that also has connectivity.

Thus, present embodiments provide a low power operating mode for RANs or, more specifically, radio base stations (e.g., gNBs) of RANs, in which a connectivity criterion (e.g., a classification tag) is provided for each UE that indicates whether a particular device is considered to be an essential or a non-essential device and/or, in some embodiments, may indicate other sustainability/power management related information. Using a structure (e.g., “SUSTANABILITY: LABEL”), where “LABEL” in one example is “ESSENTIAL” or “NON-ESSENTIAL” enables many power optimization strategies to be supported. This supports an approach for selecting particular gNBs that can operate in a low power mode.

Thus, the embodiments presented herein provide an improved approach to managing power in a radio access network by enabling some radio base stations to be powered down when a smaller number of radio base stations are capable of satisfying quality of service demands. In particular, UEs that are not necessary for operations at particular times can be disconnected from the network, and/or UEs that are necessary can be moved to common radio base stations, which causes certain radio base stations to no longer have associated UEs, enabling those radio base stations to be powered down. This provides the practical application of reducing overall power consumption of a radio access network, providing both energy and cost savings.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description and appended claims, or may be learned by the practice of embodiments as set forth hereinafter.

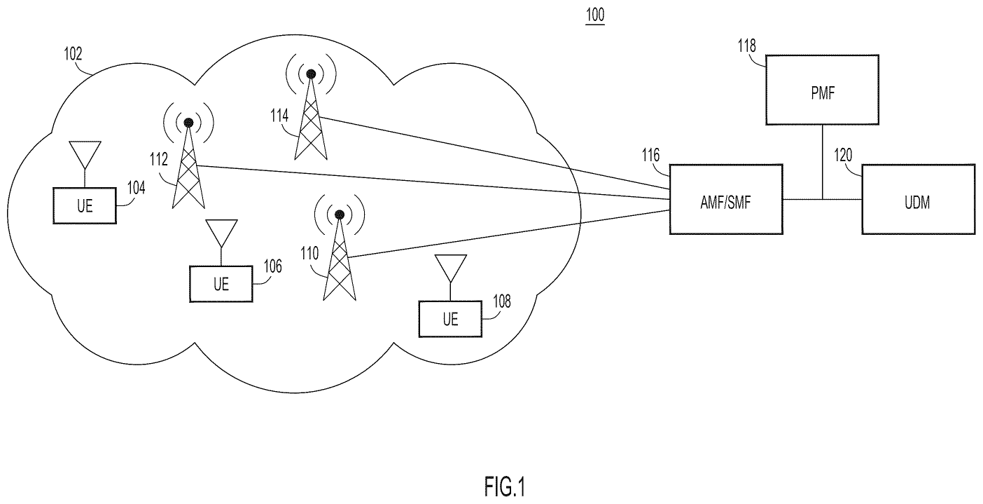

Embodiments will now be described in detail with reference to the Figures. Reference is now made to FIG. 1. FIG. 1 depicts an environment 100 for providing a low power operating mode for a radio access network, according to an example embodiment. As depicted, environment 100 includes a radio access network (RAN) 102 that includes a plurality of UEs (e.g., UE 104, UE 106, and UE 108) and a plurality of radio base stations (e.g., radio base stations 110, 112, and 114). Also include in environment 100 is an Access and Mobility Function/Session Management Function (AMF/SMF) 116, a power management function (PMF) 118, and a Unified Data Management (UDM) function 120.

In the depicted example, RAN 102 may correspond to a Third Generation Partnership Project (3GPP) Fifth Generation (5G) network, next Generation (nG) network, or the like. As such, radio base stations 110, 112, and 114 may each correspond to a gNodeB (gNB), which can include a physical entity, such as a radio tower, a virtual entity, such as a software defined radio (SDR), or a combination thereof. It should be appreciated that the number of radio base stations and/or the number of UEs that are shown in the depicted embodiment are provided to facilitate a clear description of the various embodiments presented herein, and that RAN 102 may include any number of radio base stations and/or UEs.

UEs 104, 106, and 108 may each include any wireless electronic device that initiates a connection or communication session with a wireless network (e.g., RAN 102), and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, a router or gateway with a wireless interface, a wireless enabled device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more wireless networks, such as radio base stations 110, 112, and/or 114 of RAN 102. UEs 104, 106, and 108 may each be configured to connect to both 5G networks.

Any network functions can be employed in environment 100; as depicted, the network functions include AMF/SMF 116, PMF 118, and UDM 120 and may be representative of a 5G mobile core network. It should be appreciated that these functions can be implemented in various configurations (such as implementing the logic of some functions within other functions), and that a 5G mobile core network may include other functions that are not depicted in the example embodiment of environment 100 to facilitate description of the various embodiments presented herein. As one example, PMF 118 may be logic that is implemented within AMF/SMF 116.

AMF/SMF 116 may include one or more network functions that perform operations such as UE registration management, connection management (e.g., establishing control plane connections with UEs), reachability management, mobility management (e.g., maintaining knowledge of UE locations within a network), access authentication, session management, and the like. AMF/SMF 116 can be implemented together or may be separate network functions (e.g., an AMF and separate SMF). AMF/SMF 116 may be responsible for notifying PMF 118 when UEs register and establish protocol data unit (PDU) sessions.

In some embodiments, AMF/SMF 116 is provided with an RFSP index for a normal power operating mode and an RFSP index for a low power operating mode for the radio base stations of RAN 102. Current 3GPP standards provide for dynamic Access Management (AM) policies that may be utilized by the core network to cause a UE to latch onto a particular Radio Access Technology (RAT) type by providing a RFSP value or index for the particular RAT type to the UE. For example, a 3GPP 5G radio node, such as a gNodeB, can make use of an RFSP index for radio resource management such that the mobile core network or, more specifically a mobility management node within the mobile core network, such as AMF/SMF 116, can use the RFSP index for a particular RAT type to direct the UE to latch on to/connect to the particular RAT type through dynamically updating an AM policy for the UE for various reasons, such as network congestion, coverage issues, etc. In the embodiments described herein, RESP indices can be overloaded or enhanced with additional data in order to indicate different power operating modes to be utilized by the various radio base stations.

PMF 118 may perform power management operations in accordance with the embodiments presented herein. PMF 118 can obtain data relating to the power utilization or consumption of RAN 102; specifically, the power consumption of radio base stations 110, 112, and 114 and, in some embodiments, the power consumption of the various network functions. Through AMF/SMF 116, PMF 118 can obtain data indicating the number of devices connected to each radio base station in RAN 102, and through UDM 120, PMF 118 can obtain subscriber data that includes a tag indicating the connection criteria of devices (e.g., whether a particular UE is essential or non-essential for operations of an enterprise).

PMF 118 may be configured to trigger a change in a power operating mode of radio base stations of RAN 102, including a change from a normal power operating mode to a low power operating mode or a change from a low power operating mode to a normal power operating mode. The conditions for placing the radio base stations into a particular power operating mode can be defined based on one or more user-defined events occurring and/or based on one or more events occurring that are identified using a machine learning model.

In some embodiments, a condition for switching one or more radio base stations from a normal power operating mode to a low power operating mode may include a session count of UEs in RAN 102 falling to or below a threshold number or percentage. For example, if a RAN has fifty devices during peak usage hours and falls to ten devices at off-peak hours, a threshold may be defined as twenty devices, and once there are twenty or fewer devices connected to the RAN, PMF 118 can be configured to place one or more radio base stations in a low power operating mode. Percentage thresholds can likewise be used; for example, if the UEs in a RAN fall below a threshold that is 40% of the peak usage amount, then one or more radio base stations of the RAN may be placed in a low power operating mode. In some embodiments, PMF 118 can be configured to switch between power operating modes at certain times of day, week, or month, etc. In some embodiments, PMF 118 can be configured to place one or more radio base stations in a particular power operating mode when certain devices, groups of devices, or classes of devices become connected or disconnected to the RAN.

In some embodiments, PMF 118 utilizes a machine learning model to determine the condition(s) for placing one or more radio base stations of a RAN in a particular power operating mode. A machine learning model, such as a neural network (e.g., a convolutional neural network, recurrent neural network, etc.), can be trained using training data that includes example sets of activity in a RAN over time, and these example sets can be labeled with respect to a point in time at which one or more radio base stations of the RAN were placed in a particular power operating mode. The activity can include a session count of UEs over time, a number of active radio base stations over time, a ratio of active radio base stations to UEs over time, a count of active UEs by a particular category or role of device over time, and the like. Thus, the machine learning model can be trained to identify thresholds, based on particular conditions occurring in a RAN, when one or more radio base stations of the RAN should be placed into a particular power operating mode.

These examples for determining conditions for placing one or radio base stations in a particular operating power mode are only a few of the many conditions that could be determined for managing radio base station operating power modes. Virtually any other conditions, criteria, etc. could be envisioned for managing the operating power mode(s) of radio base stations and, thus, are clearly within the scope of the teaching of the present disclosure.

UDM 120 may include functions for storing and managing network user data. UDM 120 can be paired with a user data repository that stores user data such as customer profile information, customer authentication information, encryption keys, connectivity criteria, and the like. UDM 120 may reside on the control plane and utilize microservices to communicate between the user plane and control plane. UDM 120 may store connectivity criteria for each UE (e.g., UEs 106, 106, and 108) that indicates whether or not each UE should remain connected to RAN 102 during a low power operating mode. In some embodiments, the connectivity criteria may be a binary definition of whether a device should remain connected (e.g., a tag indicating that the device is “essential”) or should be disconnected (e.g., a tag indicating that the device is “non-essential”) during a low power operating mode. In some embodiments, devices can be assigned priorities using the defined connectivity criteria; for example, a low-priority device may be disconnected during a low power operating mode, whereas a medium-priority device may remain connected, but can be handed over to a different radio base station, if necessary, and a high-priority device must remain connected to its current radio base station to ensure operations are not disrupted. In some embodiments, the connectivity criteria may indicate that a device can be disconnected during a low power mode only if another device or set of devices is also disconnected.

During operation of environment 100, one or more radio base stations (e.g., any of radio base stations 110, 112, and 114) may be powered down during a low power operating mode. In at least one embodiment, placing a radio base station into a low power operating mode may include powering down the radio base station, which may include disabling power to an antenna such that a transmitter or receiver has zero wattage. In other embodiments, placing a radio base station into a low power operating mode may include causing the radio base station to operate at a reduced transmission wattage. In other embodiments, placing a radio base station into a low power operating mode may include causing the radio base station to enter into a standby state and await further instructions (e.g., wake-up, normal operating power mode, etc.). The power that should be provided to any radio base stations at a given time can be determined by PMF 118, which controls the power operating mode by causing a RFSP index update to be provided to the radio base stations via an AMF. Although only low and normal operating power modes are discussed for examples herein, it is to be understood that multiple operating power modes may be configured for an environment, each mapped to a corresponding RFSP index.

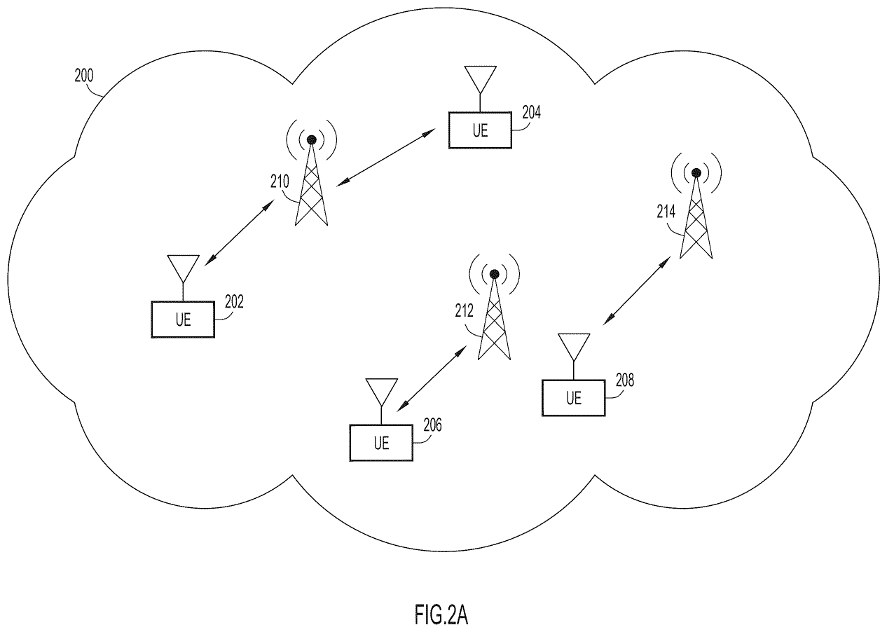

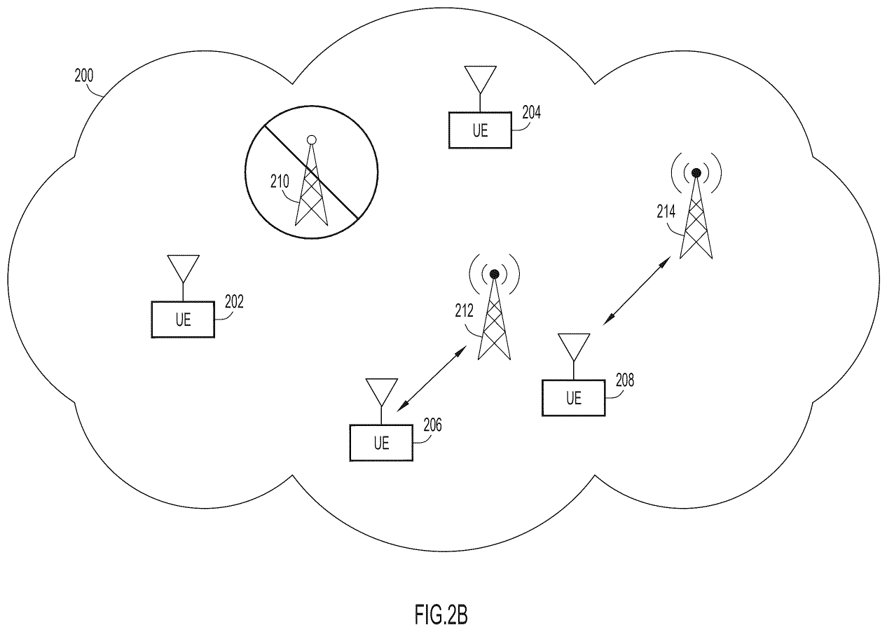

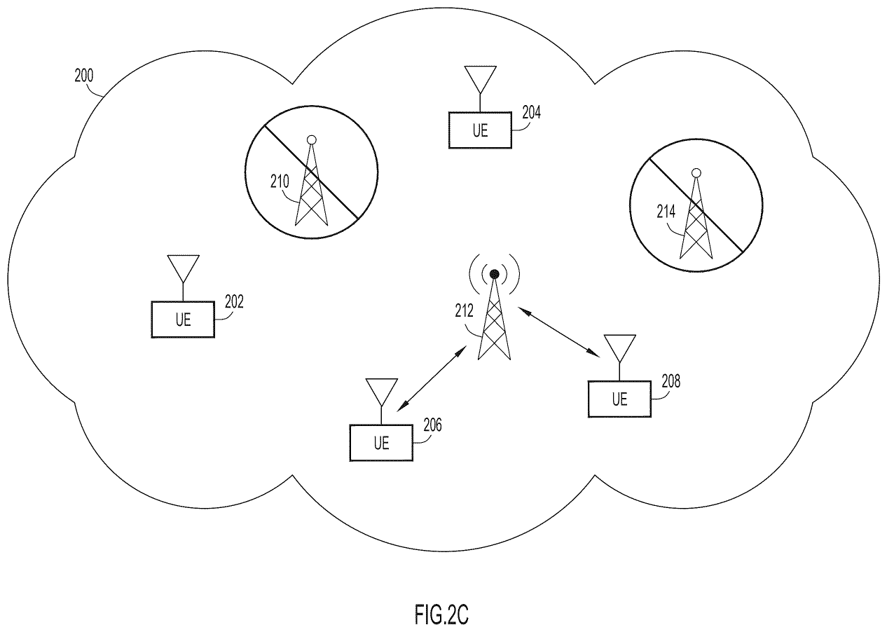

With reference now to FIGS. 2A-2C, FIGS. 2A-2C are block diagrams depicting a RAN 200 in which a low power operating mode is activated, according to an example embodiment. As depicted, RAN 200 includes four UEs (UE 202, UE 204, UE 206, and UE 208) and three radio base stations (radio base station 210, radio base station 212, and radio base station 214). In the depicted examples, RAN 200 is shown with radio base stations 210, 212, and 214 in a normal power operating mode in FIG. 2A, whereas FIGS. 2B and 2C show low power operating modes. FIGS. 2B and 2C can be different low power operating modes or FIG. 2B can depict an intermediate state of RAN 200 as RAN 200 may be transitioned to a state of consuming minimal power due to all of the radio base stations being transitioned to the low power mode depicted in FIG. 2C. It should be appreciated that the various network functions and other components of a RAN are not depicted in the examples of FIGS. 2A-2C in order to provide a clear description of the statuses of the depicted entities during various power operating modes.

Initially, RAN 200 is shown in FIG. 2A as having three radio base stations 210, 212, and 214, each operating in a normal power operating mode. UE 202 and UE 204 are connected to radio base station 210, UE 206 is connected to radio base station 212, and UE 208 is connected to radio base station 214.

In FIG. 2B, at least one radio base station of RAN 200 has been placed in a low power operating mode. For example, based on the connectivity criteria for the UEs, radio base station 210 can be placed in a low power operating mode. Specifically, UEs 202 and 204 may have connectivity criteria indicating that UEs 202 and 204 are not essential for operations, whereas UEs 206 and 208 may have connectivity criteria indicating that UEs 206 and 208 are essential. As such, since radio base station 210 is not supporting any essential UEs and may be caused to enter into a low power operating mode (e.g., powered down, placed into a low power/stand-by state, etc.).

In FIG. 2C, two of the radio base stations of RAN 200 are in a low power operating mode. In this depicted embodiment, UEs 202 and 204 are not required to be provided service, and as such, radio base station 210 is powered down. Additionally, UE 208 has been handed over to radio base station 212, meaning that radio base station 214 now no longer has clients and can accordingly be powered down as well. Thus, radio base station 212 provides service to UEs 206 and 208 during this low power operating mode.

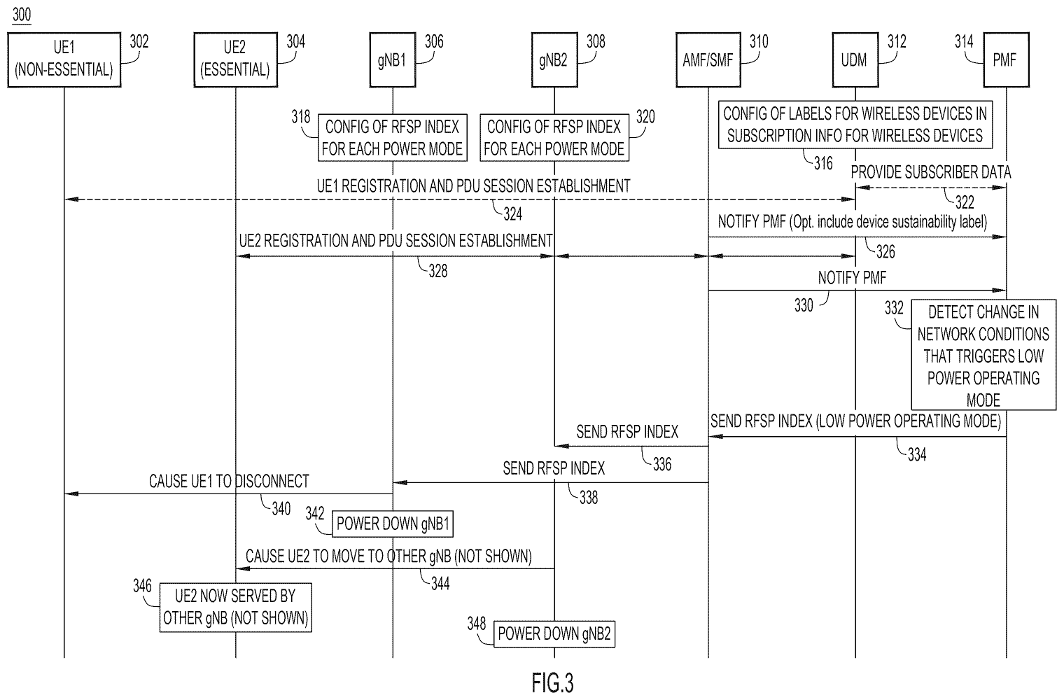

FIG. 3 is a signaling flow diagram depicting a method 300 for providing a lower power operating mode for a radio access network, according to an example embodiment. As depicted, method 300 has entities that include UEs (UE1 302 and UE2 304), gNBs (gNB1 306 and gNB2 308), an AMF/SMF 310, a UDM 312, and a PMF 314. The RAN to which the entities of method 300 correspond may include other UEs, gNBs, and/or other network functions, which are not depicted in this example.

PMF 314 may be configured to monitor and manage various aspects of a RAN that relate to power consumption. PMF 314 can obtain data that includes power utilization in a RAN, the number of active gNBs in a RAN, the active device (e.g., UE) count at each gNB, the connectivity criterion for each device (e.g., “SUSTAINABILITY: LABEL”, in which LABEL can be “ESSENTIAL” or “NON-ESSENTIAL”), historical trend data of an enterprise's operations, historical data of UEs (including Quality of Service (QOS) Class Identifier (QCI) data, signal strength data, PDU count data, etc.), the geographical locations of physical gNBs, the current and/or historical load in the AMF (e.g., AMF/SMF 310), the active PDU sessions in the AMF, and/or any other relevant data obtained from or by UEs, radio base stations, and/or network functions.

At operation 316, UDM 312 is provided or obtains a configuration of labels for wireless device from the subscription information for the wireless devices. The labels may indicate whether or not each UE should be connected to a RAN during a low power operating mode. In the depicted embodiment, UE1 302 has a label of “non-essential”, meaning that UE1 302 need not remain connected to the RAN during the low power operating mode of a given radio base station, whereas UE2 304 has the label of “essential” and should remain connected to a radio base station of the RAN. UE labels can be defined when onboarding a device onto a network, and can be stored in a database that associates the label with a device's profile, including Subscriber Identity Module (SIM) credentials, etc.

At operation 318, gNB1 306 is provided with a configuration of RFSP indices. An RFSP index can be provided for each power operating mode; in the depicted embodiment, there is an RFSP index for a normal power operating mode and another RFSP index for a low power operating mode. Each RFSP index indicates how to manage client device (e.g., UEs) for the given power operating mode. As such, the RFSP index for the low power operating mode can indicate whether a device should be disconnected during the low power operating mode. Likewise, gNB2 308 is similarly configured with the RFSP indices at operation 320. Initially, both gNB1 306 and gNB2 308 are assumed to be operating in a normal power operating mode.

At operation 322, subscriber data is optionally provided to PMF 314 by UDM 312 or obtained by PMF 314 from UDM 312. The subscriber data can include some or all of the subscription information that is maintained by UDM 312. In particular, the subscriber data includes the connectivity criteria labels for each UE.

Next, the UEs connect to the RAN (e.g., a particular base station of the RAN) and perform a registration and PDU session establishment with the 5G network. For example, at operation 324, consider UE1 302 with the 5G mobile core network and establishes PDU session via AMF/SMF 310 through connection with gNB1 306. Through the registration/PDU session establishment, AMF/SMF 310 queries UDM 312 for subscription information for UE1 302, including the connectivity criteria configured for UE1 302. During or after this process, AMF/SMF 310 notifies PMF 314 at operation 326 regarding the UE1 registration/session establishment and identifies the gNB to which the UE1 302 is connected via the RAN. Optionally, the AMF/SMF 310 can inform PMF 314 of the device's connectivity criteria (e.g., based on the sustainability label of the UE) in embodiments in which PMF 314 has not already obtained or been provided with this data (e.g., in embodiments in which operation 322 is not performed). Likewise, at operation 328, AMF/SMF 310 queries UDM 312 for subscription information for UE2 304, and AMF/SMF 310 PMF 314 regarding the UE2 304 registration/session establishment and identifies the gNB to which the UE2 304 is connected at operation 330.

At this point, UE1 302 and UE2 304 are connected to the RAN the 5G mobile core network and may participate in any authorized network operations, such as calls or data transmissions.

At operation 332, consider that PMF 314 detects a change in network conditions that triggers entry of specific radio base stations into a low power operating mode. The specific event(s) that cause this can be user-defined or learned by a machine learning algorithm, and can include session count, time of day, or other some other event or combination of events occurring. Once PMF 314 detects a change in the network conditions, PMF 314 triggers one or more radio base stations of the RAN to enter into a low power operating mode. In some embodiments, PMF 314 can be configured with RFSP indices that indicates operating mode mappings for various power operating modes, and PMF 314 can send the appropriate RFSP index and identify a radio base station (e.g., gNB2 308) that is placed in a low power operating mode. (as shown when PMF 314 transmits the RFSP index for the low power operating mode to AMF/SMF 310 at operation 334). In other embodiments, PMF 314 may not be configured with mappings of RFSP indices to power operating modes, and can instead notify AMF/SMF 310 to place particular radio base stations (e.g., gNB 2 308) into a low power operating mode, in which case AMF/SMF 310 can send the appropriate RFSP index to the particular radio base station (e.g., gNB 308 at operation 336). AMF/SMF 310 thus provides the new RFSP index to each gNB (gNB1 306, gNB2 308, and at least one other gNB, not shown) at operation 336 and 338. When each gNB receives the RFSP index, the gNB performs operations according to the RFSP index to disconnect UEs and/or handover UEs to other radio base stations. In the depicted embodiment gNB1 306 only has one client, UE1 302, and gNB1 306 causes UE1 302 to disconnect from the RAN at operation 340. In some embodiments, gNB1 306 can use a Handover Command message to perform this operation, which is part of the Radio Resource Control. In 5G networks, the Handover Command message is a control message sent from a source gNB to a UE to instruct the UE to perform a handover to a target gNB. This message is part of the handover process, which aims to ensure continuous and seamless connectivity for the UE as it moves between different cells or gNBs. The Handover Command message typically contains the following information: Target gNB Identity (which identifies the gNB to which the UE is instructed to handover), Timing Information (which includes details about when the handover should occur, such as timing advance or time offset parameters, to synchronize the handover process), Measurement Results (which includes information about the signal quality and other parameters measured by the UE, which may have influenced the decision to initiate the handover), and/or Configuration Parameters (which includes any additional parameters necessary for the UE to perform the handover successfully, such as radio resource configuration information).

Alternatively, if gNB1 306 is shut down, any client UE will find the best available gNB that is operating.

Now that gNB1 306 has no clients, gNB 1 306 can be powered down at operation 342.

At operation 344, gNB2 308 causes UE2 304 to be handed over to another gNB (not shown in the depicted embodiment) at operation 346, as UE2 304 is labeled as an essential UE. The handover may include an Xn or N2 handover, as outlined in the 3GPP specifications of TS 38.401, TS 38.423, and/or TS 38.300. Thus, service can continue to be provide to UE2 304. At operation 348, gNB2 308 may likewise be powered down. Thus, power savings can be achieved in method 300 by disconnecting and/or handing over UEs in a manner that enables radio base stations to be powered down while still providing RAN connectivity to essential UEs.

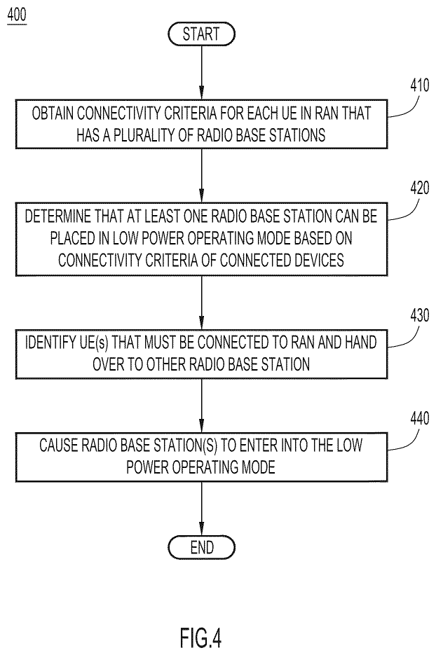

FIG. 4 is a flow chart depicting a method 400 for providing a low power operating mode for a radio access network, according to an example embodiment.

A connectivity criterion is obtained for each UE in a RAN that has a plurality of radio base stations at operation 410. The connectivity criterion can indicate whether a UE should be provided with access to a RAN during a low power operating mode, and can be obtained from a UDM 312, where connectivity criteria may be stored along with other subscriber data. The connectivity criteria can be obtained by a PMF that monitors the RAN for various events to determine whether an event occurs that satisfies a defined condition for causing the RAN to enter a low power operating mode.

At operation 420, it is determined that at least one radio base station can be placed in a low power operating mode based, at least in part, on the connectivity criteria of connected devices. The PMF may determine that a condition has been triggered to enter the RAN into the low power operating mode, and the PMF can analyze the connectivity criteria of connected UEs to identify any UEs that are labeled as not essential for operations. Next, the PMF can transmit an updated RFSP index to the radio base stations of the non-essential UEs, by way of an AMF, to cause the non-essential UEs to be disconnected from the RAN.

One or more UEs that must be connected to the RAN are identified and handed over to other radio base stations at operation 430. The PMF can analyze the RAN to identify any essential UEs that are connected to different radio base stations, and can cause those UEs to be handed over to a same base station via another updated RFSP index. Not all essential UEs are required to be handed over, as some essential UEs may already be connected to a radio base station that will remain powered in the low power operating mode. Thus, by pooling essential UEs at a minimal number of radio base stations, other radio base stations may no longer have clients and can be powered down during the low power operating mode.

The radio base stations without any clients are caused to enter into the low power operating mode at operation 440. Since one or more radio base stations no longer have clients, either by disconnecting or handing over UEs formerly associated with the radio base stations, those radio base stations can be powered down by reducing or eliminating power to one or more components of the radio base stations, including the antennae and/or other computing or networking components.

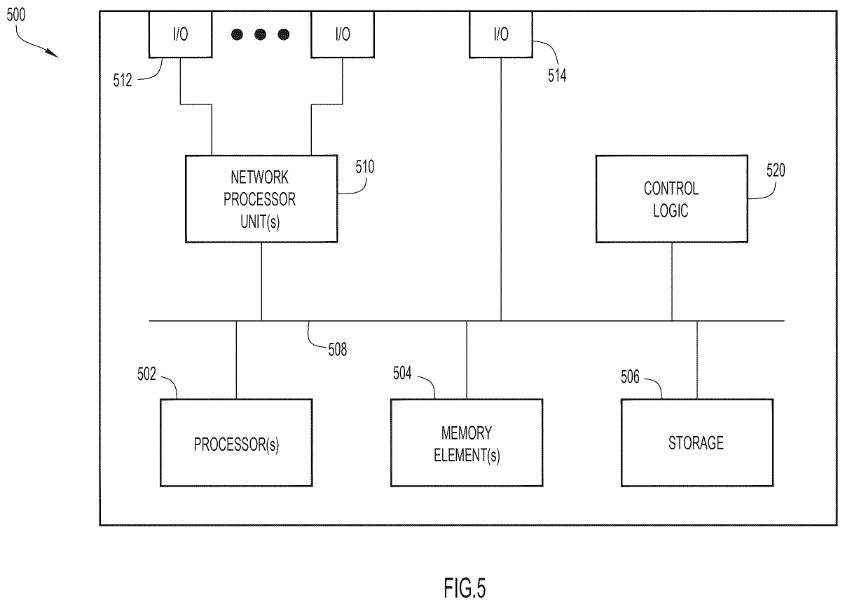

Referring now to FIG. 5, FIG. 5 illustrates a hardware block diagram of a computing device 500 that may perform functions associated with operations discussed herein in connection with the techniques depicted in FIGS. 1-4. In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O 514 allow for input and output of data and/or information with other entities that may be connected to computing device 500. For example, I/O 514 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

In general, per-3GPP standards for a mobile core network, an AMF interfaces with a SMF which can further interface with one or more UPFs. An AMF and an SMF can further interface with PCF, a UDM/UDR, and various other core network functions via 3GPP Service-Based Interface (SBI) constructs/interfaces and/or any other 3GPP interfaces/reference points. An AMF and a UPF can further interface with a RAN node, such as one or more gNBs or disaggregated components thereof.

A wireless device may be considered any electronic device, etc. that initiates a connection or communication session with a corresponding core network, and may be inclusive of but not limited to a computer, a mobile phone or mobile communication device, an electronic tablet, a laptop, etc., an electronic device such as an industrial device (e.g., a robot), automation device, enterprise device, appliance, Internet of Things (IoT) device, and/or any other device, component, element, or object capable of initiating voice, audio, video, media, or data exchanges within a system. Thus, a wireless device may include any hardware and/or software to perform baseband signal processing (such as modulation/demodulation) as well as hardware (e.g., baseband processors (modems), transmitters and receivers, transceivers, and/or the like), software, logic and/or the like to facilitate signal transmissions and signal receptions via antenna assemblies (not shown) in order to connect to one or more radio nodes of one or more RAN(s).

Generally, an AMF may facilitate access and mobility management control/services for one or more wireless devices seeking connection to/connected to a mobile core network. Generally, an SMF may be responsible for wireless device session management, with individual functions/services being supported on a per-session basis in order to facilitate data transfer(s) between a wireless device and one or more networks via one or more UPFs. Generally, a UPF may operate to provide packet routing and forwarding operations for user data traffic and may also perform a variety of functions such as packet inspection, traffic optimization, Quality of Service (QoS), policy enforcement and user data traffic handling (e.g., to/from one or more data networks), billing operations (e.g., accounting, etc.), among other operations, for wireless device sessions. Typically, a UDM stores subscription data (typically in combination with a UDR) for subscribers (e.g., a user that may be associated with a given wireless device) that can be retrieved and/or otherwise obtained/utilized during operation of a core network system. Typically, a PCF stores policy data in order to provide policy control services (e.g., to facilitate access control for one or more devices, network selection, etc.). Typically, a charging function (CHF) provides support for charging services such as facilitating the transfer of policy counter information associated with subscriber spending limits, etc.

In general, authentication services may include authenticating and/or authorizing one or more device(s) for one or more connections and/or communications and may be inclusive of any Authentication, Authorization, and Accounting (AAA) services that may be facilitated via any combination of authentication/authorization protocols such as Remote Authentication Dial-In User Service (RADIUS), DIAMETER, Extensible Authentication Protocol (EAP) [including any EAP variations], and/or the like. Generally, authentication refers to a process in which an entity's identity is authenticated, typically by providing evidence that it holds a specific digital identity such as an identifier/identity and corresponding credentials/authentication attributes/etc. Generally, authorization can be used to determine whether a particular entity is authorized to perform a given activity.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method including: obtaining connectivity criteria for each of a plurality of user equipment (UEs) connected to a radio access network including a plurality of radio base stations; determining that at least one radio base station of the plurality of radio base stations can be placed in a low power operating mode based, at least in part, on the connectivity criteria of one or more user equipment connected to the at least one radio base station; and causing the at least one radio base station to enter into the low power operating mode.

In some aspects, the techniques described herein relate to a method, wherein determining that the at least one radio base station can be placed in the low power operating mode includes determining, based on the connectivity criteria for each UE that is connected to the at least one radio base station, that each UE that is connected to the at least one radio base station can be disconnected from the radio access network during the low power operating mode.

In some aspects, the techniques described herein relate to a method, further including: providing, for each of the plurality of radio base stations, a first power profile that is mapped to a first Radio Access Technology (RAT)/Frequency Selection Priority (RFSP) index, wherein the first power profile is associated with a normal power operating mode, and a second power profile that is mapped to a second RFSP index, wherein the second power profile is associated with the low power operating mode.

In some aspects, the techniques described herein relate to a method, wherein a Power Management Function causes the at least one radio base station to enter the low power operating mode by: causing an Access and Mobility Management Function (AMF) to send the second RFSP index to the at least one radio base station.

In some aspects, the techniques described herein relate to a method, wherein determining that the at least one radio base station can be placed in the low power operating mode is further based on: identifying one or more UEs that are connected to the at least one radio base station and that are required to be connected to the radio access network based on the connectivity criteria.

In some aspects, the techniques described herein relate to a method, wherein causing the at least one radio base station to enter into the low power operating mode further includes: causing the one or more UEs identified as being required to be connected to the radio access network to be handed over to a different radio base station and then causing the at least one radio base station to enter into the low power operating mode.

In some aspects, the techniques described herein relate to a method, wherein placing the at least one radio base station in the low power operating mode is performed when a defined condition is satisfied, and wherein the defined condition includes a session count of UEs in the radio access network satisfying a threshold value.

In some aspects, the techniques described herein relate to a method, wherein placing the at least one radio base station in the low power operating mode is performed when a defined condition is satisfied, and wherein the defined condition is based on historical trend data of UE activity in the radio access network.

In some aspects, the techniques described herein relate to a method, wherein the defined condition is determined using a machine learning model to analyze the historical trend data.

In some aspects, the techniques described herein relate to a method, wherein the connectivity criteria for each UE is obtained when each UE registers with a mobile core network via the radio access network.

In some aspects, the techniques described herein relate to a method, wherein the connectivity criteria indicates that a particular UE is required to be connected to the radio access network if a particular device is connected to the radio access network, and that the particular UE can be disconnected from the radio access network if the particular device is disconnected from the radio access network.

In some aspects, the techniques described herein relate to a system including: one or more computer processors; one or more computer readable storage media; and program instructions stored on the one or more computer readable storage media for execution by at least one of the one or more computer processors, the program instructions including instructions to: obtain connectivity criteria for each of a plurality of user equipment (UEs) connected to a radio access network including a plurality of radio base stations; determine that at least one radio base station of the plurality of radio base stations can be placed in a low power operating mode based, at least in part, on the connectivity criteria of one or more user equipment connected to the at least one radio base station; and cause the at least one radio base station to enter into the low power operating mode.

In some aspects, the techniques described herein relate to a system, wherein determining that the at least one radio base station can be placed in the low power operating mode includes determining, based on the connectivity criteria for each UE that is connected to the at least one radio base station, that each UE that is connected to the at least one radio base station can be disconnected from the radio access network during the low power operating mode.

In some aspects, the techniques described herein relate to a system, wherein the program instructions further include instructions to: provide, for each of the plurality of radio base stations, a first power profile that is mapped to a first Radio Access Technology (RAT)/Frequency Selection Priority (RFSP) index, wherein the first power profile is associated with a normal power operating mode, and a second power profile that is mapped to a second RFSP index, wherein the second power profile is associated with the low power operating mode.

In some aspects, the techniques described herein relate to a system, wherein a Power Management Function causes the at least one radio base station to enter the low power operating mode by: causing an Access and Mobility Management Function (AMF) to send the second RFSP index to the at least one radio base station.

In some aspects, the techniques described herein relate to a system, wherein determining that the at least one radio base station can be placed in the low power operating mode is further based on: identifying one or more UEs that are connected to the at least one radio base station and that are required to be connected to the radio access network based on the connectivity criteria.

In some aspects, the techniques described herein relate to a system, wherein the program instructions to cause the at least one radio base station to enter into the low power operating mode further include instructions to: cause the one or more UEs identified as being required to be connected to the radio access network to be handed over to a different radio base station and then causing the at least one radio base station to enter into the low power operating mode.

In some aspects, the techniques described herein relate to one or more non-transitory computer readable storage media having program instructions embodied therewith, the program instructions executable by a computer to cause the computer to perform operations including: obtaining connectivity criteria for each of a plurality of user equipment (UEs) connected to a radio access network including a plurality of radio base stations; determining that at least one radio base station of the plurality of radio base stations can be placed in a low power operating mode based, at least in part, on the connectivity criteria of one or more user equipment connected to the at least one radio base station; and causing the at least one radio base station to enter into the low power operating mode.

In some aspects, the techniques described herein relate to one or more non-transitory computer readable storage media, wherein determining that the at least one radio base station can be placed in the low power operating mode includes determining, based on the connectivity criteria for each UE that is connected to the at least one radio base station, that each UE that is connected to the at least one radio base station can be disconnected from the radio access network during the low power operating mode.

In some aspects, the techniques described herein relate to one or more non-transitory computer readable storage media, wherein the program instructions further cause the computer to: provide, for each of the plurality of radio base stations, a first power profile that is mapped to a first Radio Access Technology (RAT)/Frequency Selection Priority (RFSP) index, wherein the first power profile is associated with a normal power operating mode, and a second power profile that is mapped to a second RFSP index, wherein the second power profile is associated with the low power operating mode.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining connectivity criteria for each of a plurality of user equipment (UEs) connected to a radio access network comprising a plurality of radio base stations;
determining that at least one radio base station of the plurality of radio base stations can be placed in a low power operating mode based, at least in part, on the connectivity criteria of one or more user equipment connected to the at least one radio base station; and
causing the at least one radio base station to enter into the low power operating mode.

2. The method of claim 1, wherein determining that the at least one radio base station can be placed in the low power operating mode comprises determining, based on the connectivity criteria for each UE that is connected to the at least one radio base station, that each UE that is connected to the at least one radio base station can be disconnected from the radio access network during the low power operating mode.

3. The method of claim 1, further comprising:
providing, for each of the plurality of radio base stations, a first power profile that is mapped to a first Radio Access Technology (RAT)/Frequency Selection Priority (RFSP) index, wherein the first power profile is associated with a normal power operating mode, and a second power profile that is mapped to a second RFSP index, wherein the second power profile is associated with the low power operating mode.

4. The method of claim 3, wherein a Power Management Function causes the at least one radio base station to enter the low power operating mode by:
causing an Access and Mobility Management Function (AMF) to send the second RFSP index to the at least one radio base station.

5. The method of claim 1, wherein determining that the at least one radio base station can be placed in the low power operating mode is further based on:
identifying one or more UEs that are connected to the at least one radio base station and that are required to be connected to the radio access network based on the connectivity criteria.

6. The method of claim 5, wherein causing the at least one radio base station to enter into the low power operating mode further comprises:
causing the one or more UEs identified as being required to be connected to the radio access network to be handed over to a different radio base station and then causing the at least one radio base station to enter into the low power operating mode.

7. The method of claim 1, wherein placing the at least one radio base station in the low power operating mode is performed when a defined condition is satisfied, and wherein the defined condition comprises a session count of UEs in the radio access network satisfying a threshold value.

8. The method of claim 1, wherein placing the at least one radio base station in the low power operating mode is performed when a defined condition is satisfied, and wherein the defined condition is based on historical trend data of UE activity in the radio access network.

9. The method of claim 8, wherein the defined condition is determined using a machine learning model to analyze the historical trend data.

10. The method of claim 1, wherein the connectivity criteria for each UE is obtained when each UE registers with a mobile core network via the radio access network.

11. The method of claim 1, wherein the connectivity criteria indicates that a particular UE is required to be connected to the radio access network if a particular device is connected to the radio access network, and that the particular UE can be disconnected from the radio access network if the particular device is disconnected from the radio access network.

12. A system comprising:
one or more computer processors;
one or more computer readable storage media; and
program instructions stored on the one or more computer readable storage media for execution by at least one of the one or more computer processors, the program instructions comprising instructions to:
obtain connectivity criteria for each of a plurality of user equipment (UEs) connected to a radio access network comprising a plurality of radio base stations;
determine that at least one radio base station of the plurality of radio base stations can be placed in a low power operating mode based, at least in part, on the connectivity criteria of one or more user equipment connected to the at least one radio base station; and
cause the at least one radio base station to enter into the low power operating mode.

13. The system of claim 12, wherein determining that the at least one radio base station can be placed in the low power operating mode comprises determining, based on the connectivity criteria for each UE that is connected to the at least one radio base station, that each UE that is connected to the at least one radio base station can be disconnected from the radio access network during the low power operating mode.

14. The system of claim 12, wherein the program instructions further comprise instructions to:
provide, for each of the plurality of radio base stations, a first power profile that is mapped to a first Radio Access Technology (RAT)/Frequency Selection Priority (RFSP) index, wherein the first power profile is associated with a normal power operating mode, and a second power profile that is mapped to a second RFSP index, wherein the second power profile is associated with the low power operating mode.

15. The system of claim 14, wherein a Power Management Function causes the at least one radio base station to enter the low power operating mode by:
causing an Access and Mobility Management Function (AMF) to send the second RFSP index to the at least one radio base station.

16. The system of claim 12, wherein determining that the at least one radio base station can be placed in the low power operating mode is further based on:
identifying one or more UEs that are connected to the at least one radio base station and that are required to be connected to the radio access network based on the connectivity criteria.

17. The system of claim 16, wherein the program instructions to cause the at least one radio base station to enter into the low power operating mode further comprise instructions to:
cause the one or more UEs identified as being required to be connected to the radio access network to be handed over to a different radio base station and then causing the at least one radio base station to enter into the low power operating mode.

18. One or more non-transitory computer readable storage media having program instructions embodied therewith, the program instructions executable by a computer to cause the computer to perform operations including:
obtaining connectivity criteria for each of a plurality of user equipment (UEs) connected to a radio access network comprising a plurality of radio base stations;
determining that at least one radio base station of the plurality of radio base stations can be placed in a low power operating mode based, at least in part, on the connectivity criteria of one or more user equipment connected to the at least one radio base station; and
causing the at least one radio base station to enter into the low power operating mode.

19. The one or more non-transitory computer readable storage media of claim 18, wherein determining that the at least one radio base station can be placed in the low power operating mode comprises determining, based on the connectivity criteria for each UE that is connected to the at least one radio base station, that each UE that is connected to the at least one radio base station can be disconnected from the radio access network during the low power operating mode.

20. The one or more non-transitory computer readable storage media of claim 18, wherein the program instructions further cause the computer to:
provide, for each of the plurality of radio base stations, a first power profile that is mapped to a first Radio Access Technology (RAT)/Frequency Selection Priority (RFSP) index, wherein the first power profile is associated with a normal power operating mode, and a second power profile that is mapped to a second RFSP index, wherein the second power profile is associated with the low power operating mode.
